(19) United States
(12) Patent Application Publication
(10) Pub. No.: US 2021/0232483 A1
(43) Pub. Date: Jul. 29, 2021

(54) LOG ANALYSIS DEVICE, LOG ANALYSIS METHOD, AND PROGRAM

(71) Applicant: NEC Corporation, Minato-ku, Tokyo (JP)

(72) Inventor: Ryosuke TOGAWA, Tokyo (JP)

(73) Assignee: NEC Corporation, Minato-ku, Tokyo (JP)

(21) Appl. No.: 17/258,308

(22) PCT Filed: Jul. 11, 2018
(86) PCT No.: PCT/JP2018/026196

§ 371 Date: Jan. 6, 2021

(51) Int. Cl. G06F 11/34; G06F 16/23; G06F 11/30

(52) U.S. Cl. CPC G06F 11/3476; G06F 11/3065; G06F 11/302; G06F 16/2358

(57) ABSTRACT

A log monitoring unit configured to output an alert in a case where a log message to be monitored satisfies a predetermined condition, and an associated log extraction unit configured to extract an associated log that is a log associated with the alert from the log message based on the alert outputted by the log monitoring unit are included. The alert outputted by the log monitoring unit and information corresponding to the associated log extracted by the associated log extraction unit are outputted.

### TECHNICAL FIELD

The present invention relates to a log analysis device, a log analysis method, and a program.

### BACKGROUND ART

A technique for monitoring log messages such as system logs and application logs is known.

For example, Patent Document 1 describes a log analysis system that has a format determination unit, a group determination unit, a connection information acquisition unit, a log aggregation unit, and an information output unit. According to Patent Document 1, the format determination unit determines which of predetermined formats each of output logs has, and the group determination unit determines which groups the logs of each determined format belong to. The connection information acquisition unit acquires connection information showing a relationship of components having output the logs of each determined group. The log aggregation unit aggregates the logs of each group for each of the components. After that, the information output unit outputs an aggregation result for each of the components based on the connection information.

Further, a related technique is described in, for example, Patent Document 2. Patent Document 2 describes a log analysis device that collects logs, stores the logs and also stores log templates that are significant parts extracted from the logs, and groups and stores based on concurrent characteristics of the log templates. According to Patent Document 2, the log analysis device generates information showing logs in real time based on the abovementioned information. Moreover, the log analysis device calculates the number of times of occurrence of transition of information including the abovementioned information, extracts and stores information causing transition, compares a log with transition occurred with stored transition, and displays transition of the log.

### Patent Document 1: WO 2017/110996

Patent Document 2: Japanese Unexamined Patent Application Publication No. JP-A 2015-095060

When performing log analysis, it is necessary to check a number of logs outputted from a system. There are a large number of logs required to check when performing analysis. As a result, there is a problem that it is difficult to check logs.

To such a problem, the technique described in Patent Document 1 does not present any means for solving the abovementioned problem although an aggregation result is outputted. The technique described in Patent Document 2 merely presents transition of logs and cannot solve the abovementioned problem. Thus, there is still a problem that when performing log analysis, there are a large number of logs to be analyzed and it is hard for a person to check the logs.

### SUMMARY

Accordingly, an object of the present invention is to provide a log analysis device, a log analysis method and a program which solve the problem that when performing log analysis, there are a large number of logs to be analyzed and it is hard for a person to check the logs.

In order to achieve the object, a log analysis device according to an aspect of the present invention includes: a log monitoring unit configured to output an alert in a case where a log message to be monitored satisfies a predetermined condition; and an associated log extraction unit configured to extract an associated log that is a log associated with the alert from the log message based on the alert outputted by the log monitoring unit. The alert outputted by the log monitoring unit and information corresponding to the associated log extracted by the associated log extraction unit are outputted.

Further, a log analysis method according to another aspect of the present invention is a log analysis method by an information processing device. The method includes: outputting an alert in a case where a log message to be monitored satisfies a predetermined condition; extracting an associated log that is a log associated with the alert based on the outputted alert; and outputting the outputted alert and information corresponding to the extracted associated log.

Further, a program according to another aspect of the present invention is a computer program including instructions for causing an information processing device to realize: a log monitoring unit configured to output an alert in a case where a log message to be monitored satisfies a predetermined condition; and an associated log extraction unit configured to extract an associated log from the log message based on the alert outputted by the log monitoring unit, the associated log being a log associated with the alert. The alert outputted by the log monitoring unit and information corresponding to the associated log extracted by the associated log extraction unit are outputted.

With the configurations as described above, the present invention can provide a log analysis device, a log analysis method and a program which solve the problem that when performing log analysis, there are a large number of logs to be analyzed and it is hard for a person to check the logs.

### BRIEF DESCRIPTION OF DRAWINGS

FIG. 1 is a block diagram showing an example of a configuration of a log analysis device in a first example embodiment of the present invention;

FIG. 2 is a view showing an example of a log message shown in FIG. 1;

FIG. 3 is a view showing an example of a monitoring rule stored in a monitoring rule storage unit shown in FIG. 1;

FIG. 4 is a view showing an example of clustering performed by an alert analysis unit shown in FIG. 1;

FIG. 5 is a view showing an example of a pattern which a log classification unit shown in FIG. 1 generates based on the log message shown in FIG. 2;

FIG. 6 is a view showing an example of an aggregation process performed by a log summarization unit shown in FIG. 1;

FIG. 7 is a view showing another example of the aggregation process performed by the log summarization unit shown in FIG. 1;

FIG. 8 is a view showing an example of a content of output by an output unit shown in FIG. 1;

FIG. 9 is a flowchart showing an example of an operation of a log monitoring unit in the first example embodiment of the present invention;

FIG. 10 is a flowchart showing an example of an operation of the alert analysis unit in the first example embodiment of the present invention;

FIG. 11 is a flowchart showing an example of an operation of an associated log extraction unit in the first example embodiment of the present invention;

FIG. 12 is a flowchart showing an example of an operation of the log summarization unit in the first example embodiment of the present invention;

FIG. 13 is a view exemplifying a hardware configuration of a computer (an information processing device) capable of realizing the first example embodiment of the present invention; and

FIG. 14 is a block diagram showing an example of a configuration of a log analysis device in a second example embodiment of the present invention.

### EXEMPLARY EMBODIMENTS

### First Example Embodiment

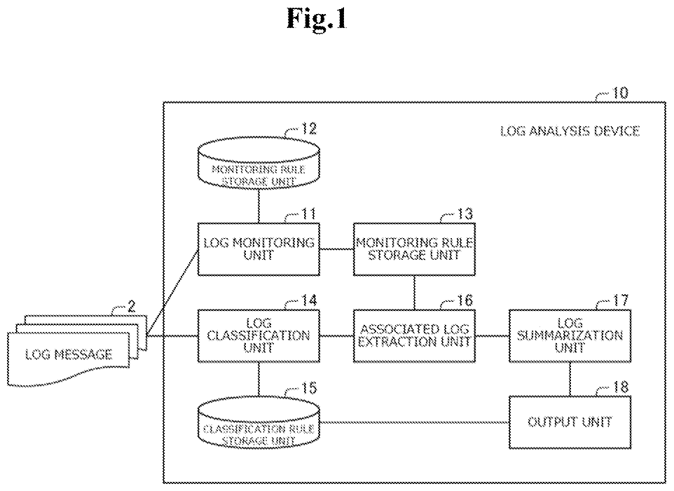

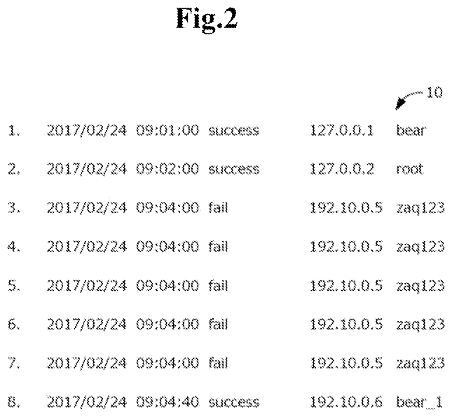

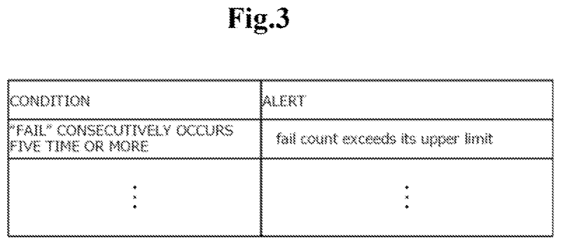

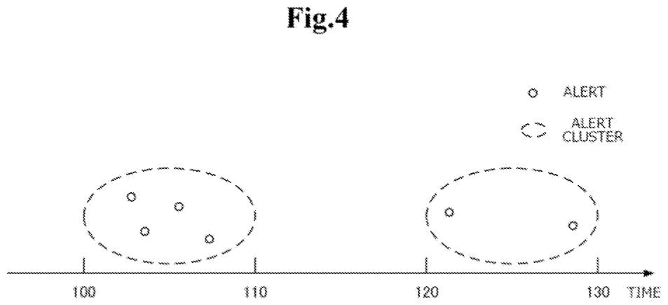

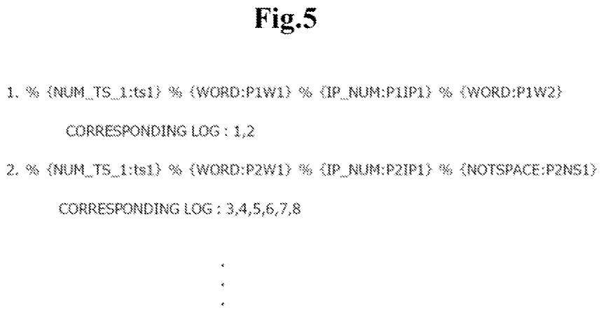

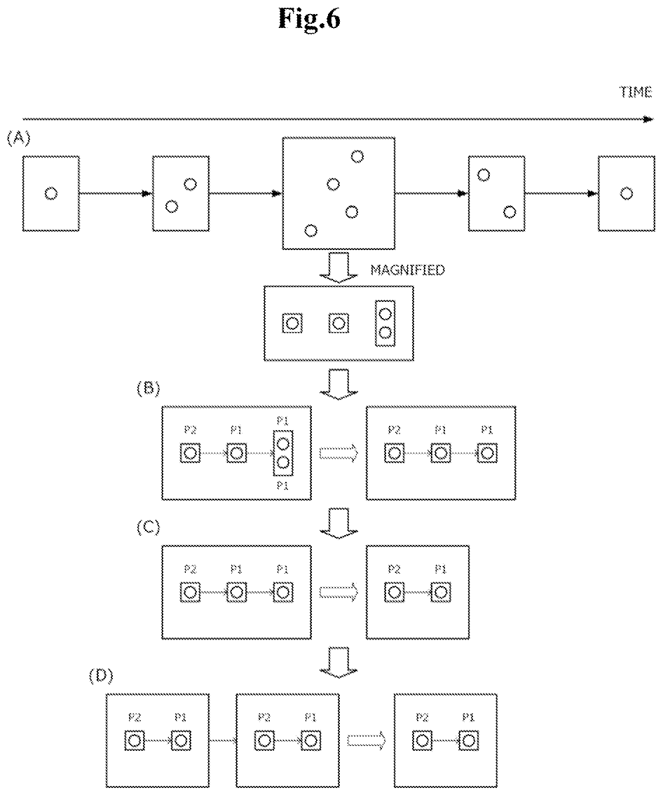

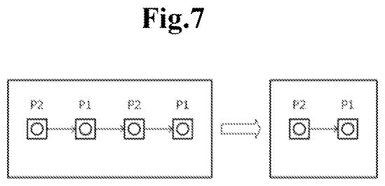

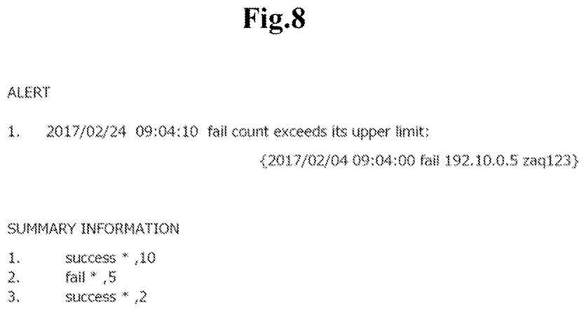

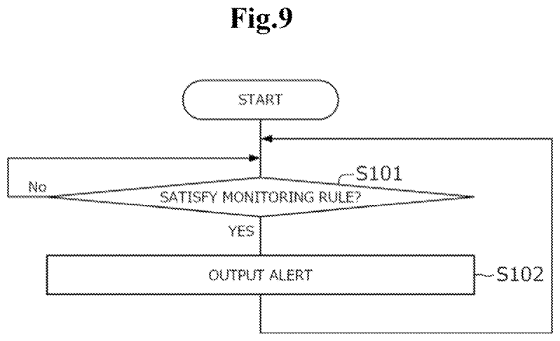

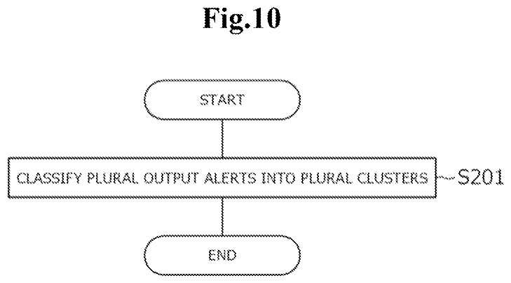

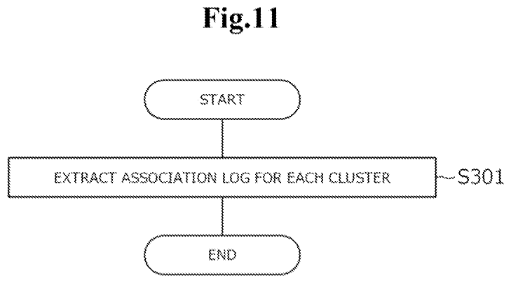

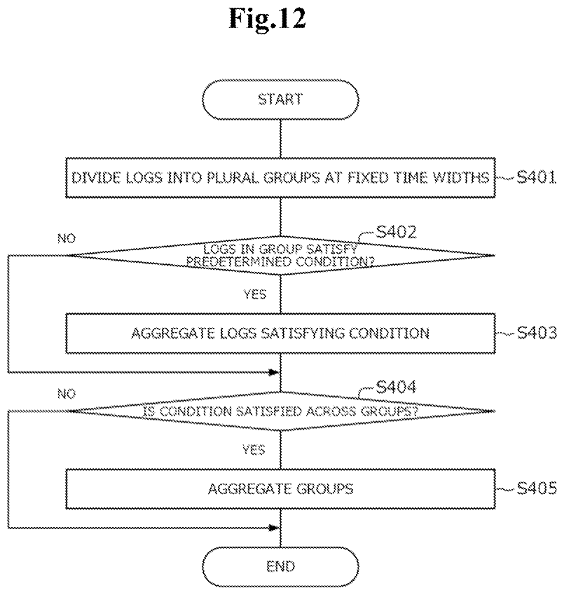

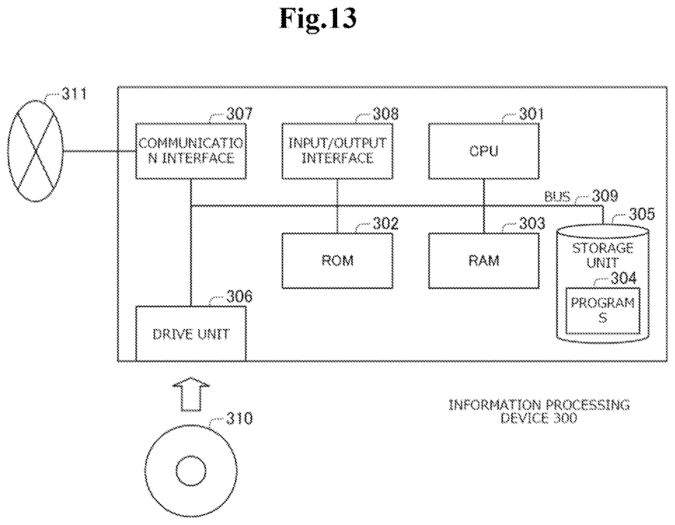

A first example embodiment of the present invention will be described with reference to FIGS. 1 to 13. FIG. 1 is a block diagram showing an example of a configuration of a log analysis device 10. FIG. 2 is a view showing an example of a log message 2. FIG. 3 is a view showing an example of a monitoring rule stored in a monitoring rule storage unit 12. FIG. 4 is a view showing an example of clustering performed by an alert analysis unit 13. FIG. 5 is a view showing an example of a pattern which a log classification unit 14 generates based on the log message 2. FIGS. 6 and 7 are views showing examples of an aggregation process performed by a log summarization unit 17. FIG. 8 is a view showing an example of a content of output by an output unit 18. FIG. 9 is a flowchart showing an example of an operation of a log monitoring unit 11. FIG. 10 is a flowchart showing an example of an operation of the alert analysis unit 13. FIG. 11 is a flowchart showing an example of an operation of an associated log extraction unit 16. FIG. 12 is a flowchart showing an example of an operation of the log summarization unit 17. FIG. 13 is a view exemplifying a hardware configuration of a computer (an information processing device) capable of realizing the log analysis device 10.

In the first example embodiment of the present invention, the log analysis device 10 that, when outputting an alert, outputs information corresponding to an associated log that is a log associated with the alert will be described. As will be described later, for each of clusters obtained by classifying alerts in accordance with chronological distribution, the log analysis device 10 extracts associated logs associated with the respective alerts in the cluster. Then, the log distribution device 10 summarizes the extracted associated logs based on patterns which the associated logs belong to, and thereafter, outputs information corresponding to the result of summarizing together with the alerts.

In this example embodiment, logs in the log message 2 each belong to some pattern. For example, a pattern is a log captured as a sequence of a plurality of variables (part of the sequence may be a fixed character string (values)). Which pattern a log belongs to can be determined, for example, from a sequence of variables when the value of each field in the log is converted into a variable corresponding to the attribute of the field. Afield refers to a range that serves as a reference for determining a value in a log or a variable. For example, a log is divided into fields at places where the content (attribute) of target/information indicated by the log changes, such as date and time, IP address (Internet Protocol address), alphabet only, alphanumeric mixture, or numbers only. Fields may be separated at places other than those exemplified above; for example, different fields for date and time. Moreover, variables corresponding to the attributes of fields are, for example, alphabets only (WORD), alphanumeric mixture (NOTSPACE), and numbers only (NUM). The variable may be variables obtained by subdividing the abovementioned ones or variables other than those exemplified above; for example, a variable indicating only numbers indicating date and time, and a variable indicating IP address.

For example, in the case of a log “2017/02/24 09:01:00 success 127.0.0.1 bear”, the log contains four fields; a field of date and time, a field of alphabets only, a field of IP address, and a field of alphabets only. Moreover, in the case of the abovementioned log, the value of the field of date and time is 2017/02/24 09:01:00, the value of the first field of alphabets only is success, the value of the field of IP address is 127.0.0.1, and the value of the second field of alphabets only is bear. When the values of the respective fields in the log are converted into variables, for example, a pattern “%{NUM_TS%{WORD}%{IP_NUM}%{WORD}” is obtained. That is to say, the value “2017/02/24 09:01:00” corresponds to the variable %{NUM_TS}, the value “success” corresponds to the variable %{WORD}, the value “127.0.0.1” corresponds to the variable %{IP_NUM}, and the value “bear” corresponds to the variable %{WORD}. In this case, it can be said that the log “2017/02/24 09:01:00 success 127.0.0.1 bear” belongs to the pattern “%{NUM_TS%{WORD}%{IP_NUM}%{WORD}”.

The log analysis device 10 is an information processing device that outputs information corresponding to an associated log together with an alert when outputting the alert. FIG. 1 shows an example of a configuration of the log analysis device 10. Referring to FIG. 1, the log analysis device 10 includes, for example, a log monitoring unit 11, a monitoring rule storage unit 12, an alert analysis device 13, a log classification unit 14, a classification rule storage unit 15, an associated log extraction unit 16, a log summarization unit 17, and an output unit 18.

The log monitoring unit 11 detects an anomaly based on a predetermined monitoring rule. Then, the log monitoring unit 11 outputs an alert showing the content of detection. In other words, the log monitoring unit 11 detects an anomaly and output an alert in a case where the log message 2 to be monitored satisfies a monitoring rule that is a predetermined condition.

For example, it is assumed that the log analysis device 10 receives the log message 2 as shown in FIG. 2 from an external device or the like. Referring to FIG. 2, the log message 2 contains logs, for example, “2017/02/24 09:01:00 success 127.0.0.1 bear”, “2017/02/24 09:02:00 success 127.0.0.2 root”, “2017/02/24 09:04:00 fail 192.10.0.5 zaq123”, “2017/02/24 09:04:00 fail 192.10.0.5 zaq123”, “2017/02/24 09:04:00 fail 192.10.0.5 zaq123”, “2017/02/24 09:04:00 fail 192.10.0.5 zaq123”, “2017/02/24 09:04:00 fail 192.10.0.5 zaq123”, “2017/02/24 09:04:40 success 192.10.0.6 bear_1”.

Further, it is assumed that a monitoring rule as shown in FIG. 3 is stored as a predetermined monitoring rule in the monitoring rule storage unit 12. Referring to FIG. 3, for example, a monitoring rule that an alert “fail count exceeds its upper limit” is outputted on a condition that ““fail” consecutively occurs five times or more” is stored in advance in the monitoring rule storage unit 12.

In such a case, since “fail” consecutively occurs five times at 09:04:00, the log monitoring unit 11 detects an anomaly based on the monitoring rule stored in the monitoring rule storage unit 12. Then, the log monitoring unit 11 outputs an alert showing the content of detection. For example, the log monitoring unit 11 outputs an alert such as “2017/02/24 09:04:10 fail count exceeds its upper limit: {2017/02/24 09:04:00 fail 192.10.0.5 zaq123}”.

Thus, the monitoring unit 11 detects an anomaly in the log message 2 based on the monitoring rule stored in the monitoring rule storage unit 12. Then, the log monitoring unit 11 outputs an alert corresponding to the result of detection.

The monitoring rule storage unit 12 is a storage device in which a monitoring rule is stored. In this example embodiment, information including a condition and an alert associated with each other is stored as a monitoring rule in the monitoring rule storage unit 12 (see FIG. 3). For example, on the first row in FIG. 3, a condition ““fail” consecutively occurs five times or more” and an alert “fail count exceeds its upper limit” are associated with each other.

A monitoring rule stored in the monitoring rule storage unit 12 may be other than the exemplified above. In this example embodiment, the number of monitoring rules stored in the monitoring rule storage unit 12 is not limited specifically. Moreover, a monitoring rule may be a rule defined by a person, or may be a model generated by machine learning.

The alert analysis unit 13 classifies a plurality of alerts outputted from the log monitoring unit 11 into a plurality of clusters in accordance with the chronological distribution of the alerts.

For example, the alert analysis unit 13 can perform cluster classification by time as shown in FIG. 4. To be specific, the alert analysis unit 13 divides a plurality of alerts outputted from the log monitoring unit 11 by a fixed time width. Then, the alert analysis unit 13 determines alerts included in the same time width as alerts included in the same cluster. For example, in the case of FIG. 4, the alert analysis unit 13 classifies four alerts existing between time 100 and time 110 into the same cluster. The alert analysis unit 13 also classifies two alerts existing between time 120 and time 130 into the same cluster. In this manner, the alert analysis unit 13 can perform cluster classification to classify alerts existing in the same time period into the same cluster. The time width may be any width.

The alert analysis unit 13 may determine to classify a plurality of alerts into other clusters in a case where a time difference between the alerts is a predetermined threshold value or more. That is to say, the alert analysis unit 13 may be configured to perform cluster classification based on a time difference between alerts and a threshold value. The threshold value may be any value.

Further, for example, the alert analysis unit 13 can add information on the occurrence source of an alert and perform cluster classification. To be specific, the alert analysis unit 13 can determine a plurality of alerts as alerts included in the same cluster in a case where the alerts are caused by any common device, log file or log message and the alerts are included in a predetermined time width (may be any width).

Further, for example, the alert analysis unit 13 may generate a cluster from the chronological distribution of alerts by a known machine learning method.

The alert analysis unit 13 can classify a plurality of alerts outputted from the log monitoring unit 11 into a plurality of clusters in accordance with the chronological distribution of the alerts by any of the abovementioned methods or a combination thereof.

In this example embodiment, timing for the alert analysis unit 13 to start the abovementioned classification process is not limited specifically. For example, the alert analysis unit 13 may perform the abovementioned classification at predetermined periods, or may perform the abovementioned classification every time the number of alerts having not been classified becomes a predetermined number or more. The alert analysis unit 13 may start the classification process at timing other than the exemplified above; for example, every time the log monitoring unit 11 outputs an alert.

The log classification unit 14 determines a pattern to which each log included in the log message 2 belongs. In other words, the log classification unit 14 classifies each log included in the log message 2 in accordance with a pattern to which the log belongs. Then, the log classification unit 14 stores the result of classification into the classification rule storage unit 15.

For example, the log classification unit 14 determines a pattern to which a log belongs based on the sequence of variables when the values of the respective fields in the log are converted into the variables. For example, it is assumed that the log classification unit 14 receives the log message 2 as shown in FIG. 2. In the case shown in FIG. 2, the sequence of variables when the values of the respective fields of the first log and the second log are converted into the variables is “only numbers indicating date and time, only alphabets, only numbers indicating IP address, only alphabets”. Then, the log classification unit 14 determines that the first and second logs in FIG. 2 belong to a pattern “%{NUM_TS}%{WORD}%{IP_NUM}%{WORD}”. Moreover, in the case shown in FIG. 2, the sequence of variables when the values of the respective fields of the third to eighth logs are converted into the variables is “only numbers indicating date and time, only alphabets, only numbers indicating IP address, alphanumeric mixture”. Then, the log classification unit 14 determines that the third and eighth logs in FIG. 2 belong to a pattern “%{NUM_TS}%{WORD}%{IP_NUM}%{NOTSPACE}”. In this manner, the log classification unit 14 classifies each log included in the log message 2 based on a pattern to which the log belongs.

The log classification unit 14 may classify logs by using a method other than the exemplified above. For example, the log classification unit 14 may be configured to divide each log included in the log message 2 into a plurality of subsets by using cluster analysis or the like and, for each subset obtained by division, determine a pattern based on the sequence of variables when the values of the fields are converted into the variables. The log classification unit 14 may be configured to determine a pattern to which a log belongs by using another known method.

The classification rule storage unit 15 is a storage device in which correspondence between logs classified by the log classification unit 14 and patterns is stored. For example, in the case shown by FIGS. 2 and 5, in the classification rule storage unit 15, the first and second logs in FIG. 2 and the pattern “%{NUM_TS}%{WORD}%{IP_NUM}%{WORD}” are associated with each other and stored. Moreover, in the classification rule storage unit 15, the third to eighth logs in FIG. 2 and the pattern “%{NUM_TS}%{WORD}%{IP_NUM}%{NOTSPACE}” are associated with each other and stored.

The associated log extraction unit 16 extracts, for each cluster outputted from the alert analysis unit 13, an associated log that is a log included in the log message 2 and associated with each alert in the cluster. For example, assuming that three alerts are included in a certain cluster, the associated log extraction unit 16 extracts an associated log for each of the three alerts included in the cluster.

For example, the associated log extraction unit 16 extracts an associated log based on information of the occurrence source of each alert. To be specific, for example, the associated log extraction unit 16 extracts an associated log based on information of an alert occurrence source and information showing a time period between the time of an alert at the earliest time and the time of an alert at the latest time among alerts in a cluster. For example, the associated log extraction unit 16 extracts, as an associated log, a log made in the abovementioned time period among logs outputted from the same occurrence source (device or the like) as a log that is the cause of an alert.

Further, the associated log extraction unit 16 can extract, as an associated log, a log outputted from a physically or virtually related device with an alert occurrence source device (for example, a device having a connection relation such as being directly connected), in addition to the abovementioned extracted associated log. For example, the associated log extraction unit 16 identifies a device that is physically or virtually related to an alert occurrence source based on topology information or the like. Then, the associated log extraction unit 16 extracts a log made in the abovementioned time period from logs outputted from the identified device having a connection relation as the associated log.

Thus, the associated log extraction unit 16 can extract, as an associated log, a log output in the same time period as an alert from a device that is an alert occurrence source or a log output in the same time period as an alert from a device having a connection relation with the device that is the alert occurrence source.

The log summarization unit 17 summarizes associated logs extracted by the associated log extraction unit 16 based on patterns to which the associated logs belong for each cluster.

FIG. 6 shows an example of processing by the log summarization unit 17. Referring to FIG. 6, the log summarization unit 17 further divides associated logs for each cluster based on the chronology. For example, the log summarization unit 17 divides associated logs in a cluster at fixed time widths as shown in FIG. 6A. In the case of FIG. 6A, the log summarization unit 17 divides associated logs in a cluster into five groups in accordance with the chronology. In the case of FIG. 6A, for example, a group on the left side is a group at the earlier time. The time width may be any width.

Subsequently, the log summarization unit 17 summarizes associated logs contained in a group by aggregating the associated logs included in the group in accordance with patterns to which the associated logs belong. That is to say, the log summarization unit 17 performs summarization for each group based on patterns.

Aggregation of associated logs can be performed, for example, by using patterns. For example, it is assumed that aggregation of two logs “2017/02/24 09:01:00 success 127.0.0.1 bear” and “2017/02/24 09:02:00 success 127.0.0.2 root” that belong to a pattern “%{NUM_TS}%{WORD}%{IP_NUM}%{WORD}” is performed. In this case, the log summarization unit 17 can aggregate the two logs “2017/02/24 09:01:00 success 127.0.0.1 bear” and “2017/02/24 09:02:00 success 127.0.0.2 root” into the pattern “%{NUM_TS}%{WORD}%{IP_NUM}%{WORD}”. In a case where such aggregation is performed, the pattern “%{NUM_TS}%{WORD}%{IP_NUM}%{WORD}” includes the two associated logs mentioned above. That is to say, the pattern “%{NUM_TS}%{WORD}%{IP_NUM}%{WORD}” represents the two associated logs mentioned above.

For example, as shown in FIG. 6B, in a case where associated logs belonging to the same pattern exist at the same time, the log summarization unit 17 aggregates the associated logs existing at the same time into one. In the case of FIG. 6B, two associated logs belonging to a pattern P1 exist at the third time. Then, the log summarization unit 17 aggregates the two associated logs into one. In a case where a plurality of associated logs belonging to the same pattern exist at the same time, the log summarization unit 17 may aggregate all the logs existing at the same time into one.

Further, as shown in FIG. 6C, in a case where associated logs belonging to the same patterns are consecutive, the log summarization unit 17 aggregates the consecutive same patterns into one. In the case of FIG. 6C, as a result of aggregating the two associated logs in FIG. 6B, the patterns P1 are consecutive at the second time and the third time. Then, the log summarization unit 17 aggregates the consecutive two associated logs (the third associated log is the result of aggregation in FIG. 6B) into one. In a case where a plurality of same patterns are consecutive, the log summarization unit 17 may aggregate all the consecutive patterns into one.

For example, in the abovementioned manner, the log summarization unit 17 performs summarization for each group. The log summarization unit 17 may be configured to execute only one of the summarizations exemplified above, or may be configured to execute some of the summarizations in combination.

Further, the log summarization unit 17 may be configured to perform summarization of logs in a group by a method other than those exemplified above. For example, as shown in FIG. 7, in a case where the same sequence is repeated (that is, a sequence of the same pattern is repeated) in a group, the log summarization unit 17 can aggregate associated logs repeating the same sequence into one. In the case of FIG. 7, a sequence in which an associated log belonging to a pattern 2 is followed by an associated log belonging to a pattern P1 is repeated. Then, the log summarization unit 17 aggregates the repeated sequences into one. As a result, one sequence in which a log belonging to the pattern 2 is followed by a log belonging to the pattern P1 is left. In a case where a plurality of same sequences are consecutive, the log summarization unit 17 may aggregate all the consecutive sequences into one.

The log summarization unit 17 may be configured to perform summarization of associated logs in a group by combining the method as shown in FIG. 7 that is other than the method illustrated in FIG. 6 with the method illustrated in FIG. 6.

Further, the log summarization unit 17 performs summarization across groups by performing aggregation across groups.

For example, as shown in FIG. 6D, in a case where the same sequences are consecutive across a plurality of groups, the log summarization unit 17 can summarize the groups into one group. In the case of FIG. 6D, a log belonging to the pattern P2 is followed by a log belonging to the pattern P1 in one group, and a log belonging to the pattern P2 is followed by a log belonging to the pattern P1 in another group following the one group. That is to say, the same sequences are consecutive across two consecutive groups. Then, the log summarization unit 17 aggregates the two groups having the same sequences into one. As a result, the two groups are aggregated into one. In a case where a plurality of groups having the same sequences are consecutive, the log summarization unit 17 may aggregate all the consecutive groups into one.

For example, in the abovementioned manner, the log summarization unit 17 performs summarization across groups. The log summarization unit 17 may be configured to perform aggregation across groups by using a method other than the method exemplified above.

As described above, the log summarization unit 17 performs summarization for each group, and also performs summarization across groups. Meanwhile, the log summarization unit 17 may be configured to perform only either the summarization for each group or the summarization across groups.

The output unit 18 outputs an alert outputted by the log monitoring unit 11, and also outputs information corresponding to the result of summarization of, for example, associated logs belonging to the same cluster as the alert. For example, the output unit 18 outputs the abovementioned information to a screen display device such as an LCD (Liquid Crystal Display) included by the log analysis device 10 or to an external device.

For example, the output unit 18 can output an alert outputted by the log monitoring unit 11, and can also output the result of summarization (patterns, associated logs) or the like as it is. At this time, the output unit 18 may output information of an associated log included in a pattern (for example, information of a value included in each variable).

Further, as shown in FIG. 8, the output unit 18 can output an alert outputted by the log monitoring unit 11, and can also output summary information corresponding to the result of summarization. Summary information includes, for example, information representing part of a pattern that is the result of summarization (for example, the value of a predetermined field of the pattern), information representing the frequency of output of the pattern, and so on. The output unit 18 may output information other than the information exemplified above as summary information. The output unit 18 may be configured to include, instead of the value of a predetermined field, the value of a field specified based on the result of calculation of the distribution of values included in the respective variables in the pattern into summary information. The output unit 18 may be configured to include the value of a field specified by a method other than the method exemplified above.

The output unit 18 may be configured to output the result of summarization as it is and also output summary information.

The above is an example of the configuration of the log analysis device 10. Subsequently, an example of processing by the log analysis device 10 will be described with reference to FIGS. 9 to 12.

First, an example of an operation of the log monitoring unit 11 of the log analysis device 10 will be described with reference to FIG. 9. Referring to FIG. 9, the log monitoring unit 11 monitors the log message 2. For example, the log monitoring unit 11 monitors whether or not the log message 2 satisfies a monitoring rule stored in the monitoring rule storage unit 12 (step S101).

In a case where the log message 2 does not satisfy the monitoring rule stored in the monitoring rule storage unit 12 (step S101, NO), the log monitoring unit 11 continues monitoring. On the other hand, in a case where the log message 2 satisfies the monitoring rule stored in the monitoring rule storage unit 12 (step S101, YES), the log monitoring unit 11 outputs an alert (step S102). For example, when receiving the log message 2 as shown in FIG. 2 in a state where the monitoring rule as shown in FIG. 3 is stored in the monitoring rule storage unit 12, the log monitoring unit 11 outputs an alert because “fail” consecutively occurred five times at 09:04:00 and therefore the log message 2 satisfies the monitoring rule.

Subsequently, an example of an operation of the alert analysis unit 13 of the log analysis device 10 will be described with reference to FIG. 10. Referring to FIG. 10, the alert analysis unit 13 classifies a plurality of alerts outputted from the log monitoring unit 11 into a plurality of clusters in accordance with the chronological distribution of the alerts (step S201). For example, as shown in FIG. 4, the alert analysis unit 13 divides a plurality of alerts outputted from the log monitoring unit 11 at fixed time widths, and determines alerts included in the same time width as alerts included in the same cluster. Thus, the alert analysis unit 13 classifies the alerts into clusters of fixed time widths.

The alert analysis unit 13 may perform the classification at predetermined periods, or may perform the classification every time the number of alerts having not been classified becomes a predetermined number or more. The alert analysis unit 13 may perform the classification every time the log monitoring unit 11 outputs an alert. The alert analysis unit 13 may start the classification process at a timing other than the timing exemplified above.

Subsequently, an example of an operation of the associated log extraction unit 16 will be described with reference to FIG. 11. Referring to FIG. 11, the associated log extraction unit 16 extracts an associated log based on information of the occurrence source of each alert. To be specific, for example, the associated log extraction unit 16 extracts an associated log for each cluster based on information of the occurrence source of an alert and information showing a time period between the time of an alert at the earliest time and the time of an alert at the latest time among alerts in the cluster (step S301). The associated log extraction unit 16 may extract, as an associated log, a log outputted from a device that is the occurrence source of an alert in the same time period as the alert. The associated log extraction unit 16 may also extract, as an associated log, in addition to the abovementioned log, a log outputted from a device in the connection relation with the device that is the occurrence source of the alert in the same time period.

Subsequently, an example of an operation of the log summarization unit 17 will be described with reference to FIG. 12. Referring to FIG. 12, the log summarization unit 17 further divides associated logs extracted by the associated log extraction unit 16 for each cluster. For example, the log summarization unit 17 divides the associated logs at fixed time widths as shown in FIG. 6A (step S401).

The log summarization unit 17 summarizes associated logs included in a group by aggregating the associated logs included in the group in accordance with patterns to which the associated logs belong. For example, in a case where the associated logs included in the group satisfy a predetermined condition (step S402, YES), the log summarization unit 17 aggregates the associated logs satisfying the condition (step 403). On the other hand, in a case where the associated logs included in the group do not satisfy the predetermined condition (step S402, NO), the log summarization unit 17 does not aggregate the associated logs. The condition for the aggregation is that the same patterns exist at the same time, the same patterns are consecutive, the same sequence is repeated in a group, or the like.

Further, the log summarization unit 17 performs summarization across groups by performing aggregation across groups. For example, in a case where a predetermined condition is satisfied across groups (step S404, YES), the log summarization unit 17 aggregates the groups satisfying the condition (step S405). On the other hand, in a case where the predetermined condition is not satisfied across the groups (step S404, NO), the log summarization unit 17 does not aggregate the groups. The condition for aggregating groups is that the same sequences are consecutive across a plurality of groups, or the like.

As described above, the log analysis device 10 in this example embodiment includes the alert analysis unit 13 and the associated log extraction unit 16. With such a configuration, the associated log extraction unit 16 can extract, for each cluster outputted from the alert analysis unit 13, an associated log that is a log associated with each alert in the cluster. As a result, the output unit 18 can perform output corresponding to the extracted associated log together with the alert. This makes it possible to narrow down logs that need to be checked, and it becomes possible to solve the problem that, when performing log analysis, there are a large number of logs to be analyzed and it is difficult for a person to check.

Further, the log analysis device 10 in this example embodiment includes, in addition to the above configuration, the log classification unit 14 and the log summarization unit 17. With such a configuration, the log summarization unit 17 can aggregate associated logs based on the patterns of the associated logs determined by the log classification unit 14. As a result, the output unit 18 can perform output corresponding to the result of aggregation of the extracted associated logs together with the alert. This makes it possible to narrow down information to be checked, and it becomes possible to more sufficiently solve the abovementioned problem.

### <Hardware Configuration>

In the first example embodiment, each component included by the log analysis device 10 represents a block of a function unit. Some or all of the components included by the log analysis device 10 can be realized by any combination of an information processing device 300 and a program as shown in FIG. 13, for example. FIG. 13 is a block diagram showing an example of a hardware configuration of the information processing device 300 that realizes the respective components of the log analysis device 10. The information processing device 300 can include, for example, the following configurations.

CPU (Central Processing Unit) 301

ROM (Read Only Memory) 302

RAM (Random Access Memory) 303;

Programs 304 loaded to the RAM 303

Storage unit 305 in which the programs 304 are stored

Drive unit 306 that reads from and writes into a recording medium outside the information processing device 300

Communication interface 307 connected to a communication network 311 outside the information processing device 300

Input/output interface 308 that input and outputs data

Bus 309 that connects the respective components

The respective components included by the log analysis device 10 described above can be realized by the CPU 301 acquiring and executing the programs 304 realizing the functions of the components. The programs 304 realizing the functions of the respective components included by the log analysis device 10 are, for example, stored in the storage unit 305 or the ROM 302 in advance, and the CPU 301 loads the programs to the RAM 303 and executes the programs when necessary. The programs 304 may be supplied to the CPU 301 via the communication network 311. Alternatively, the programs 304 may be stored in a storage medium 310 in advance, and the drive unit 306 may retrieve the programs and supply to the CPU 301.

FIG. 13 shows an example of a configuration of the information processing device 300, and the configuration of the information processing device 300 is not exemplified by the abovementioned case. For example, the information processing device 300 may be configured by part of the abovementioned configuration. For example, the information processing device 300 may not include the drive unit 306.

### Second Example Embodiment

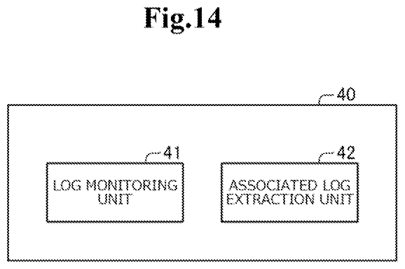

Next, a second example embodiment of the present invention will be described with reference to FIG. 14. In the second example embodiment, the overview of a configuration of a log analysis device 40 will be described.

The log analysis device 40 is an information processing device that monitors a log message and outputs an alert. FIG. 14 shows an example of the configuration of the log analysis device 40. Referring to FIG. 14, the log analysis device 40 includes, for example, a log monitoring unit 41 and an associated log extraction unit 42.

For example, the log analysis device 40 includes an arithmetic log unit such as a CPU and a storage unit. For example, the log analysis device 40 realizes the respective processing units by the arithmetic logic unit executing a program stored in the storage unit.

The log monitoring unit 41 outputs an alert in a case where a log message to be monitored satisfies a predetermined condition.

The associated log extraction unit 42 extracts, based on an alert outputted by the log monitoring unit 41, an associated log that is a log associated with the alert from a log message.

Thus, the log analysis device 40 includes the log monitoring unit 41 and the associated log extraction unit 42. With such a configuration, the log analysis device 40 can output an alert outputted by the log monitoring unit 41 and information corresponding to an associated log extracted by the associated log extraction unit 42. This makes it possible to narrow down logs that need to be checked, and it becomes possible to solve the problem that when performing log analysis, there are a large number of logs to be analyzed and it is difficult for a person to check.

Further, the log analysis device 40 can be realized by a predetermined program installed in the log analysis device 40. To be specific, a program according to another aspect of the present invention is a program causing an information processing device to realize the log monitoring unit 41 that outputs an alert in a case where a log message to be monitored satisfies a predetermined condition and the associated log extraction unit 42 that extracts, based on the alert outputted by the log monitoring unit 41, an associated log that is a log associated with the alert. The program is a program to output the alert outputted by the log monitoring unit 41 and information corresponding to the associated log extracted by the associated log extraction unit 42.

Further, a log analysis method executed by the log analysis device 40 described above is a method including outputting an alert in a case where a log message to be monitored satisfies a predetermined condition, extracting, based on the output alert, an associated log that is a log associated with the alert, and outputting the output alert and information corresponding to the extracted associated log.

The inventions of the program and the log analysis method having the above configurations can also achieve the abovementioned object of the present invention because the program and the log analysis method have the same actions as the log analysis device 40.

### <Supplementary Notes>

The whole or part of the exemplary embodiments disclosed above can be described as the following supplementary notes. Below, the overview of the log analysis device and so on according to the present invention will be described. However, the present invention is not limited to the following configurations.

### (Supplementary Note 1)

A log analysis device comprising:

a log monitoring unit configured to output an alert in a case where a log message to be monitored satisfies a predetermined condition; and

an associated log extraction unit configured to extract an associated log from the log message based on the alert outputted by the log monitoring unit, the associated log being a log associated with the alert,

wherein the alert outputted by the log monitoring unit and information corresponding to the associated log extracted by the associated log extraction unit are outputted.

### (Supplementary Note 2)

The log analysis device according to Supplementary Note 1, wherein the associated log extraction unit is configured to extract, as the associated log, a log outputted from a same occurrence source as a log having caused the alert.

### (Supplementary Note 3)

The log analysis device according to Supplementary Note 1 or 2, wherein the associated log extraction unit is configured to extract, as the associated log, a log outputted from a device physically or virtually related with a device of an occurrence source of a log having caused the alert.

### (Supplementary Note 4)

The log analysis device according to any one of Supplementary Notes 1 to 3, comprising an alert analysis unit configured to classify a plurality of alerts outputted by the log monitoring unit into a plurality of clusters in accordance with chronological distribution of the alerts,

wherein the associated log extraction unit is configured to extract, as the associated log, a log determined to have been output within a same time period as the alert based on the clusters obtained by classification by the alert analysis unit.

### (Supplementary Note 5)

The log analysis device according to any of Supplementary Notes 1 to 4, comprising:

a log classification unit configured to classify logs in the log message into predetermined patterns; and

a log summarization unit configured to perform summarization of associated logs extracted by the associated log extraction unit based on the patterns obtained by classification by the log classification unit.

### (Supplementary Note 6)

The log analysis device according to Supplementary Note 5, wherein the log summarization unit is configured to divide the associated logs extracted by the associated log extraction unit into a plurality of groups based on chronology and perform summarization of the associated logs for each of the groups.

### (Supplementary Note 7)

The log analysis device according to Supplementary Note 6, wherein the log summarization unit is configured to perform summarization of the associated logs in a case where at least one of conditions is satisfied in the group, the conditions including a case where the same patterns exist at same time, a case where the same patterns are consecutive, and a case where a sequence of the same patterns is repeated.

### (Supplementary Note 8)

The log analysis device according to any one of Supplementary Notes 5 to 7, wherein the log summarization unit is configured to divide the associated logs extracted by the associated log extraction unit into a plurality of groups based on chronology and perform summarization across the groups.

### (Supplementary Note 9)

The log analysis device according to Supplementary Note 8, wherein the log summarization unit is configured to perform summarization across the groups in a case where a sequence of the same patterns is repeated across the plurality of groups

### (Supplementary Note 10)

The log analysis device according to any one of Supplementary Notes 5 to 9, wherein the alert and summary information are outputted, the alert being outputted by the log monitoring unit, the summary information being information based on a result of summarization by the log summarization unit of the associated logs extracted by the associated log extraction unit.

### (Supplementary Note 11)

A log analysis method by an information processing device, the method comprising:

outputting an alert in a case where a log message to be monitored satisfies a predetermined condition;

extracting an associated log that is a log associated with the alert based on the outputted alert; and

outputting the outputted alert and information corresponding to the extracted associated log.

### (Supplementary Note 11-1)

The log analysis device according to Supplementary Note 11, the method comprising extracting a log outputted from a same occurrence source as a log having caused the alert, as the associated log.

### (Supplementary Note 11-2)

The log analysis device according to Supplementary Note 11 or 11-1, the method comprising extracting a log outputted from a device physically or virtually related with a device of an occurrence source of a log having caused the alert, as the associated log.

### (Supplementary Note 12)

A computer program comprising instructions for causing an information processing device to realize:

a log monitoring unit configured to output an alert in a case where a log message to be monitored satisfies a predetermined condition; and

an associated log extraction unit configured to extract an associated log from the log message based on the alert outputted by the log monitoring unit, the associated log being a log associated with the alert,

wherein the alert outputted by the log monitoring unit and information corresponding to the associated log extracted by the associated log extraction unit are outputted.

### (Supplementary Note 12-1)

The computer program according to Supplementary Note 12, wherein the associated log extraction unit extracts, as the associated log, a log outputted from a same occurrence source as a log having caused the alert.

### (Supplementary Note 12-2)

The computer program according to Supplementary Note 11 or 11-1, wherein the associated log extraction unit is configured to extract, as the associated log, a log outputted from a device physically or virtually related with a device of an occurrence source of a log having caused the alert.

The program described in the example embodiments and supplementary notes is stored in a storage device, or recorded on a computer-readable recording medium. For example, the recording medium is a portable medium such as a flexible disk, an optical disk, a magnetooptical disk, and a semiconductor memory.

Although the present invention has been described above with reference to the example embodiments, the present invention is not limited to the example embodiments. The configurations and details of the present invention can be changed in various manners that can be understood by one skilled in the art within the scope of the present invention.

### DESCRIPTION OF NUMERALS

10 log analysis device
11 log monitoring unit
12 monitoring rule storage unit
13 alert analysis unit
14 log classification unit
15 classification rule storage unit
16 associated log extraction unit
17 log summarization unit
18 output unit
2 log message
300 information processing device
301 CPU
302 ROM
303 RAM
304 programs
305 storage unit
306 drive unit
307 communication interface
308 input/output interface
309 bus
310 recording medium
311 communication network
40 log analysis device
41 log monitoring unit
42 associated log extraction unit

What is claimed is:

1. A log analysis device comprising:
a log monitoring unit configured to output an alert in a case where a log message to be monitored satisfies a predetermined condition; and
an associated log extraction unit configured to extract an associated log from the log message based on the alert outputted by the log monitoring unit, the associated log being a log associated with the alert,
wherein the alert outputted by the log monitoring unit and information corresponding to the associated log extracted by the associated log extraction unit are outputted.

2. The log analysis device according to claim 1, wherein the associated log extraction unit is configured to extract, as the associated log, a log outputted from a same occurrence source as a log having caused the alert.

3. The log analysis device according to claim 1, wherein the associated log extraction unit is configured to extract, as the associated log, a log outputted from a device physically or virtually related with a device of an occurrence source of a log having caused the alert.

4. The log analysis device according to claim 1, comprising an alert analysis unit configured to classify a plurality of alerts outputted by the log monitoring unit into a plurality of clusters in accordance with chronological distribution of the alerts,
wherein the associated log extraction unit is configured to extract, as the associated log, a log determined to have been output within a same time period as the alert based on the clusters obtained by classification by the alert analysis unit.

5. The log analysis device according to claim 1, comprising:
a log classification unit configured to classify logs in the log message into predetermined patterns; and
a log summarization unit configured to perform summarization of associated logs extracted by the associated log extraction unit based on the patterns obtained by classification by the log classification unit.

6. The log analysis device according to claim 5, wherein the log summarization unit is configured to divide the associated logs extracted by the associated log extraction unit into a plurality of groups based on chronology and perform summarization of the associated logs for each of the groups.

7. The log analysis device according to claim 6, wherein the log summarization unit is configured to perform summarization of the associated logs in a case where at least one of conditions is satisfied in the group, the conditions including a case where the same patterns exist at same time, a case where the same patterns are consecutive, and a case where a sequence of the same patterns is repeated.

8. The log analysis device according to claim 5, wherein the log summarization unit is configured to divide the associated logs extracted by the associated log extraction unit into a plurality of groups based on chronology and perform summarization across the groups.

9. The log analysis device according to claim 8, wherein the log summarization unit is configured to perform summarization across the groups in a case where a sequence of the same patterns is repeated across the plurality of groups

10. The log analysis device according to claim 5, wherein the alert and summary information are outputted, the alert being outputted by the log monitoring unit, the summary information being information based on a result of summarization by the log summarization unit of the associated logs extracted by the associated log extraction unit.

11. A log analysis method by an information processing device, the method comprising:
outputting an alert in a case where a log message to be monitored satisfies a predetermined condition;
extracting an associated log that is a log associated with the alert based on the outputted alert; and
outputting the outputted alert and information corresponding to the extracted associated log.

12. A non-transitory computer-readable recording medium having a computer program recorded thereon, the computer program comprising instructions for causing an information processing device to realize:
a log monitoring unit configured to output an alert in a case where a log message to be monitored satisfies a predetermined condition; and
an associated log extraction unit configured to extract an associated log from the log message based on the alert outputted by the log monitoring unit, the associated log being a log associated with the alert,
wherein the alert outputted by the log monitoring unit and information corresponding to the associated log extracted by the associated log extraction unit are outputted.
